(19) United States
(12) Patent Application Publication
(10) Pub. No.: US 2007/0196802 A1
(43) Pub. Date: Aug. 23, 2007

(54) Visually Enhanced Personal Music Broadcast

(75) Inventors: Oleg Beletski, Espoo (FI); Timo-Pekka Viljamaa, Helsinki (FI); Ingrid Schembri, Vantaa (FI); Jukka T. Heinonen, Helsinki (FI); Tony Niklas von Knorring, Helsinki (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/276,268

(22) Filed: Feb. 21, 2006

(51) Int. Cl. G09B 7/00; G09B 11/00

(52) U.S. Cl. 434/323

(57) ABSTRACT

A method and apparatus is provided for permitting a mobile device to provide music and related supplemental content with other users in order to enhance the music listening experience. A user may associate supplemental content with the music. The supplemental content may contain pictures or videos that are synchronized with the music. The music and supplemental content may be transmitted to other users for their viewing and listening pleasure. Feedback on the music and synchronized supplemental content may be transmitted back to the initiating entity.

### FIELD OF THE INVENTION

The invention relates generally to mobile devices. More particularly, the present invention relates to a mobile computing device having broadcast and digital communication capabilities.

### BACKGROUND OF THE INVENTION

A variety of mobile computing devices exist, such as personal digital assistants (PDAs), mobile phones, digital players, and mobile terminals. These mobile computing devices perform various functions specific to the device, and are often capable of communicating with other devices. The mobile computing devices may also be capable of receiving broadcasting services and multi-media content distributed by such broadcasting services. These devices may contain music playing devices such as MP3 players or FM receivers. For instance, a portable device may receive data streams of related information through in-band transmission such as RDS (Radio Data System) and/or DARC (Radio Data Channel—ETSI ETS 300751) and/or IBOC for analog FM radio. Additionally, these devices may include cameras for taking pictures. Many of these mobile devices may also be connected to data networks to receive limited amounts of information along with the associated music content.

The mobile computing devices may be capable of accessing services such as digital radio. Digital radio consists of radio broadcasts of data rather than analog transmissions. Because the data transmitted may include various types of information along with audio information, a mobile device receiving digital radio broadcasts may view content associated with the audio radio broadcast. Radio stations broadcasting digital radio, therefore, can transmit information, such as traffic, weather, and advertising information, simultaneous with the audio broadcast.

Another service a mobile computing device may access involves the use of radio data system (RDS). RDS includes transmission of limited amounts of data along with FM radio transmissions. The data is carried inaudibly in one or more subcarrier frequencies that are part of the baseband transmission. The amount of data that can be transmitted is relatively small and typically includes information such as program service name (PS), program identity (PI), or alternative frequencies for the station broadcast.

Another service a mobile computing device may utilize includes Visual Radio. Visual Radio allows a user to listen to a radio station and simultaneously receive visual content related to the radio station. Parallel visual content that is seen on a display of a computing device is synchronized with the radio broadcast. FIG. 1 illustrates a Visual radio system 100. With Visual Radio, a radio station 102 plans and creates a braded visual presentation with the Visual Radio Tool 104. With Visual Radio Tool 104, the radio station 102 manages visual content flow to a mobile device 108 in synchronization with a radio broadcast 109 which may include interactive content such as voting, quizzes, and purchasing. A discovery service 110 provides functionality to browse radio station presets and to locate Visual Radio service for Visual Radio enabled stations.

A Visual Radio Server (VRS) 112 connects mobile device 108 to available radio stations feeds. VRS 112 also manages data flow to and from mobile device 108, which includes timed visual content and interactive content. Visual Radio Server 112 also collects current Visual Radio service usage statistics, and provides adapted feeds for different terminal platforms. Radio stations may use digital Radio Automation Systems (RAS) 114 to operate their radio broadcast. RAS 114 may control the playing and timing of music, advertising, and other broadcast content.

A Visual Radio Application (VRA) 116 provides a mobile device user with an opportunity to listen to a radio broadcast and to receive visual content via mobile device 108. VRA 116 includes radio-related functions, such as starting and stopping the radio broadcast, and tuning to a new frequency manually or through presets, and the visual and interactive functions, such as receiving and displaying visual content and communicating the user interactions to VRS 112. Visual Radio System functions in a GPRS (General Packet Radio Service) mobile network 118 and may be connected to the VRS 112 through a SMS center 120 and gateway 122. The Visual Radio delivery system involves a two-channel approach, using a control channel over a plain TCP/IP connection and a data channel over HTTP in a classic request-response mode. A control channel is responsible for session initiation and management, time synchronization, channel connection and delivery of content control information. The control channel is implemented on top of a plain TCP/IP socket.

Although existing mobile devices may receive various sources of data and content, these mobile devices and services do not allow for sharing of data between users. For instance, users may utilize their portable mobile computing device to listen to their personal music collection. Unfortunately, a user is unable to share their personal music with others in a synchronized fashion similar to that of VRS. In addition, a user may wish to share supplemental content such as videos, pictures or other media content with another user in synchronization with a music file. Allowing a user to share music and synchronized visual content would enhance a user's media experience. Moreover, a user may wish to supply feedback to another user regarding the shared music or synchronized media file.

Thus, a need exists in the art for a method and apparatus that enables users to create and share digital music along with related synchronized supplemental content. Additionally, a need exists for providing feedback regarding the shared music and synchronized supplemental content.

### SUMMARY OF THE INVENTION

In order to overcome the above-described problems and other problems that will become apparent when reading this specification, the present invention provides methods for sharing media content and related supplemental content from a first media device to at least one additional media device. In an aspect of the invention, a music listening experience is enhanced as synchronized supplemental content is provided with shared media content. The media content may comprise a music file which may be transmitted through a first network channel to a second media device. The supplemental content which may comprise a video or picture is transmitted through a second network channel to the second media device. Feedback may be transmitted from the second media device to the first media device through a third network channel to expand or update the supplemental content.

In another aspect of the invention, a supplemental content server may be utilized to receive supplemental content which may be forwarded to additional media devices upon request. The requested supplemental content may be synchronized with the media content for simultaneous viewing by users. Other features and advantages of the invention will become apparent with reference to the following detailed description and figures.

### BRIEF DESCRIPTION OF THE DRAWINGS

The invention will be described in detail in the following description of preferred embodiments with reference to the following figures wherein:

FIG. 1 shows a prior art visual radio system including a mobile device adapted to receive radio broadcasts in accordance with an aspect of the invention;

FIG. 2 shows a diagram of a media device in accordance with an aspect of the invention;

FIG. 3 illustrates a diagram for delivering media files such as music files to other media devices in accordance with an aspect of the invention;

FIG. 4 illustrates an aspect of the invention in which a supplemental servers may be utilized to store supplemental content in accordance with an aspect of the invention;

FIG. 5 illustrates a feedback mechanism in the from of a blog server for use with an aspect of the invention;

FIG. 6 illustrates a method of the invention in which a first media device transmits media content and supplemental content through communication channels in accordance with an aspect of the invention; and

FIG. 7 illustrates a method for sharing media content and related supplemental content in accordance with an aspect of the invention.

### DETAILED DESCRIPTION OF THE INVENTION

In the following description of the various embodiments, reference is made to the accompanying drawings that form a part hereof, and in which is shown by way of illustration various embodiments in which the invention may be practiced. It is to be understood that other embodiments may be utilized and structural and functional modifications may be made without departing from the scope of the present invention.

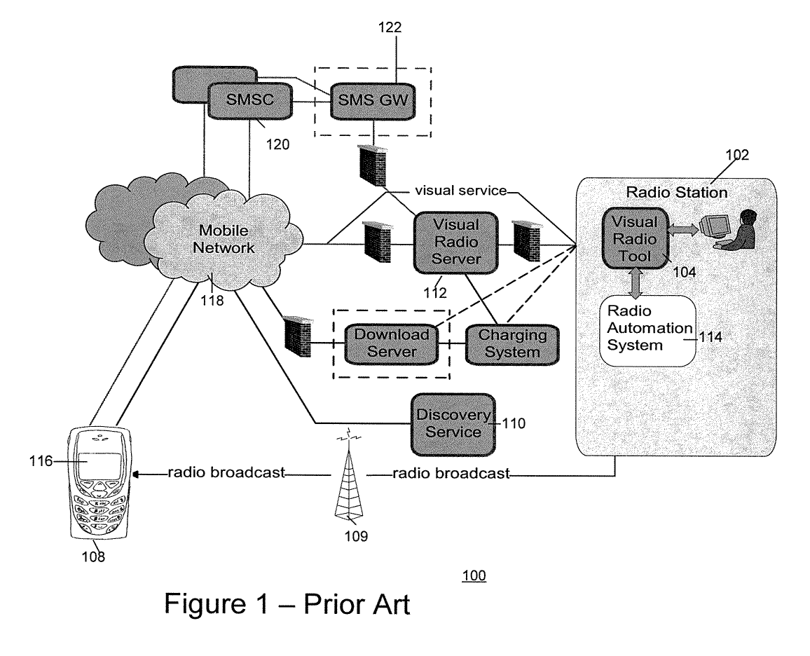

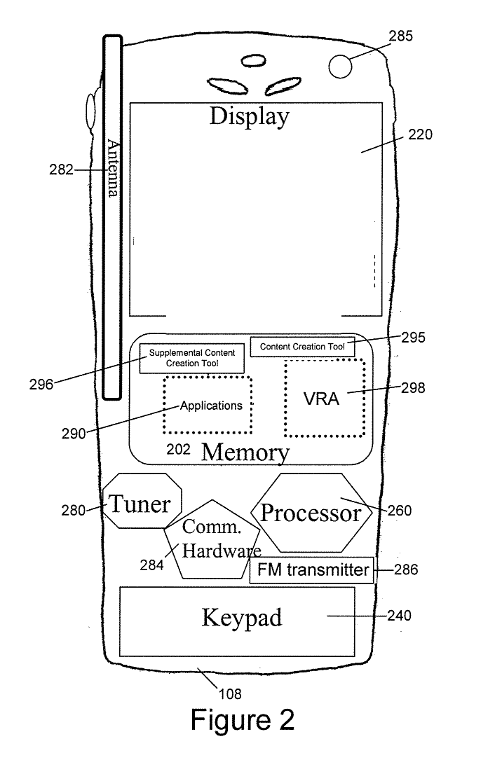

As shown in FIGS. 1 and 2, a media device 108 may be in communication with a data communication network 118 and a broadcast network 109. The media device 108 may be a mobile network-enabled device, such as a personal digital assistant (PDA), cellular telephone, mobile terminal, personal video recorder, portable television, personal computer, digital camera, digital camcorder, portable audio device, portable radio, or combinations thereof. As shown in FIG. 1, the media device 108 generally includes any mobile device capable of receiving media broadcasts and interacting with a digital communication network. The broadcast network may include radio waves associated with a radio station 102 that are transmitted from a transmitter, or may include television, satellite or other types of digital or analog broadcasts.

As shown in FIG. 2, the media device 108 may include a display screen 220, memory 202, a keypad 240, a processor 260, a radio tuner 280, a television tuner (not shown), an antenna 282, communication hardware 284, and a camera 285. In addition, media device 108 may include transmission components such as a FM transmitter 286 and a television transmitter (not shown). As is known in the art, the processor 260 performs steps according to instructions stored in the memory 202 and generally interacts with other components of the media device 108. The display screen 220 displays images and the keypad 240 is adapted to receive inputs from an operator.

The memory 202 may be implemented with any combination of read only memory modules or random access memory modules, optionally including both volatile and nonvolatile memory. Software 290 may be stored within memory 202 and/or storage to provide instructions to processor 260 for enabling mobile device 108 to perform various functions. For example, a Visual Radio Application (VRA) 298 may be stored in memory 202. Alternatively, some or all of mobile device 108 computer executable instructions may be embodied in hardware or firmware (not shown). Additionally, the memory modules may store music content in various music formats, such as MP3, and supplemental media content, such as video, images, text, and audio. Additionally, the media device 108 may comprise a media content server that manages transmission of the media content from the device 108, and a supplemental media content server that manages transmission of the supplemental media content from the device 108. Further, the media device may comprise a content creation tool/editor 295 and a supplemental content creation tool/editor 296 that are used for content selection and edition. Those tools or editors may also be a single editor.

The antenna 282 may receive radio waves in the radio broadcast network 109 transmitted by a transmitter, as is known in the art. The radio tuner 280 is connected to the antenna 282 and is adapted to tune, demodulate and amplify selected frequencies of radio waves received by antenna 282. The radio tuner 280 may be a digital phase-locked loop (PLL) synthesizer that is able to be retuned within milliseconds. The communication hardware 284 may be adapted to receive and modulate or demodulate wireless communication signals, such as microwaves, sent or received from the media device 108. In addition, the media device 108 may transmit via a FM transmitter 286 and other components (such as antenna 282 or the like) to other device capable or receiving FM signals. Thus, the mobile device 108 according to one embodiment comprises a mobile device that is capable of receiving radio station broadcasts and transmitting information via the FM transmitter 286. In addition, the media device 108 may transmit via a television transmitter to other device capable of receiving television signals. Thus, the mobile device 108 according to one embodiment comprises a mobile device that is capable of receiving television station broadcasts and transmitting information via the television transmitter (not shown). The device of the present invention, however, is not limited to any particular embodiment of a device, provided the device has data connectivity, transmission, and broadcast reception capabilities.

Further, the device 108 of present invention is not limited to any particular embodiment for enabling data connectivity or broadcast reception. For example, the media device 108 may use a circuit switched connection for data connectivity, such as a second-generation wireless system using TDMA (Time Division Multiple Access), CDMA (Code Division Multiple Access), GSM (Global System for Mobile Communications), UMTS/3G, WCDMA or other such access systems. In other examples, the media device 10 may use a packet based access system, such as GPRS (General Packet Radio Service) over a GSM network, or short range connectivity systems such as WLANs (Wireless local area networks) or BLUETOOTH. With regard to broadcast tuning, media device 108 may receive, for example, analog radio transmissions, digital radio transmissions, such as DAB (Digital Audio Broadcasting), DRM (Digital Radio Modiale), satellite radio transmissions, analog television transmissions, digital television transmissions, such as DMB (Digital Multimedia Broadcasting), DVB-H, and DVB-T, or other such broadcasts.

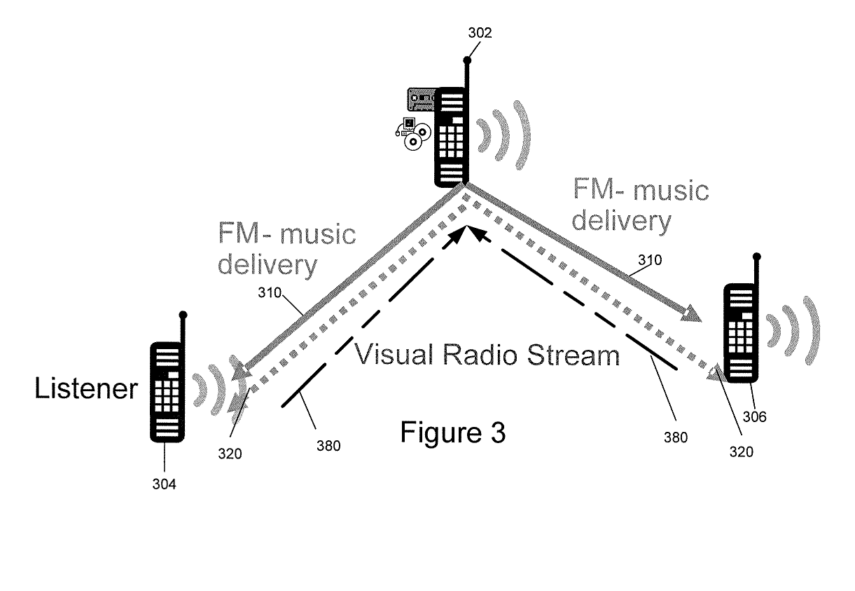

FIG. 3 illustrates a diagram for delivering media files such as music files to other media devices (304 and 306) in accordance with an aspect of the invention. In FIG. 3, a broadcasting media device 302 broadcasts a media content, such as a music file, through a low power communication protocol through a first communication channel 310 from the media content server or the media content memory. The broadcasting may include FM broadcasting. In addition, the broadcasting may be through a WLAN, a wireless telecommunication network, GPRS, GSM, or a low power communication protocol such as BLUETOOTH.

A user may select some supplemental media content, such as images, text, video or other media to broadcast along with the media content, such as the music file, using a Visual Radio content delivery chain. The Visual Radio stream may use protocols such as GPRS, 3G, BLUETOOTH, and WLAN for delivery of the images or supplemental content from the supplemental media content server or the supplemental media content memory. For instance, a user may wish to broadcast a series of pictures to be shown during the performance of a particular music piece. A user may modify attributes of a particular media file in order to link or associate the media items with each other. For example, a user may create links between pictures and selected songs on media device 302. Those links may be created through a content creation tool 295 and/or through a supplemental content creation tool 296 stored in the memory 202 of media device 302. As those skilled in the art will realize, the created links may be based on numerous attributes such as associations, places, time, emotions, and names.

For example, a user may utilize a camera 285 in a media device 302 to take pictures that the user would like to associate with a particular song. For instance, a user may take pictures of a wining sports team and associate those pictures with a song such as “We are the Champions” by Queen.

When the media device 302 takes a picture, it collects as much metadata as possible about the current moment and a time or time period. Additionally, media devices such as mobile phones may use location technologies to collect the geographical name of an area of interest. Moreover, a user may manually input the name of an event. Alternatively, a music recognition service may be utilized to retrieve information about particular music pieces of interest. A recognition service may return song metadata that includes artist name, song title, and album information. The information may be stored as metadata pertaining to the just photographed picture. When the same song is played in a media device 302, the media device 302 displays the picture during the performance of the song. For instance, a recognition service may be used to retrieve information for a background song playing in a concert, disco, or restaurant/bar. The information regarding the background music may be linked to a photograph taken by a user.

In an aspect of the invention, pictures or supplemental content may be transmitted through a second communication channel 320 to a second media device 304. Similarly, the song and the supplemental content may also be transmitted to additional media devices such as media device 306. The additional media devices, 304 and 306, enable users to listen to the delivered music and simultaneously display the received pictures in the form of a slide show of related pictures. In addition, media devices 304 and 306 may through a third communication channel 380 provide feedback to the broadcasting media device 302. Media device 302 may then create updated supplemental content based on the supplied feedback. Such feedback may include text, and/or additional media files such as pictures or audio.

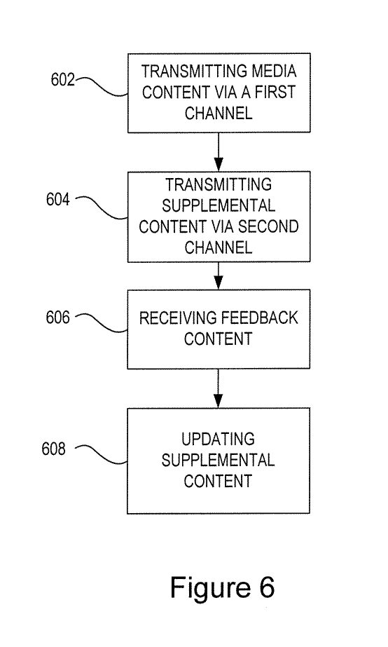

FIG. 6 illustrates a method of the invention in which at step 602 a first media device transmits media content through a first communication channel. Next in step 604, supplemental content from the first media device is transmitted through a second communication channel to a second media device. The media content may include a MP3 file and associated supplemental content that may include a video file. The second media device may play the MP3 file while simultaneously viewing the synchronized video. After listening to the music and rendering the supplemental content, such as viewing the video, a user may comment or provide feedback to the first media device through a third communication channel as shown in step 606. In step 608, the feedback may be used to update the supplemental content stored in the first media device. Additionally in step 608, the feedback may be used to edit and/or select the media content and the supplemental media content that will be transmitted.

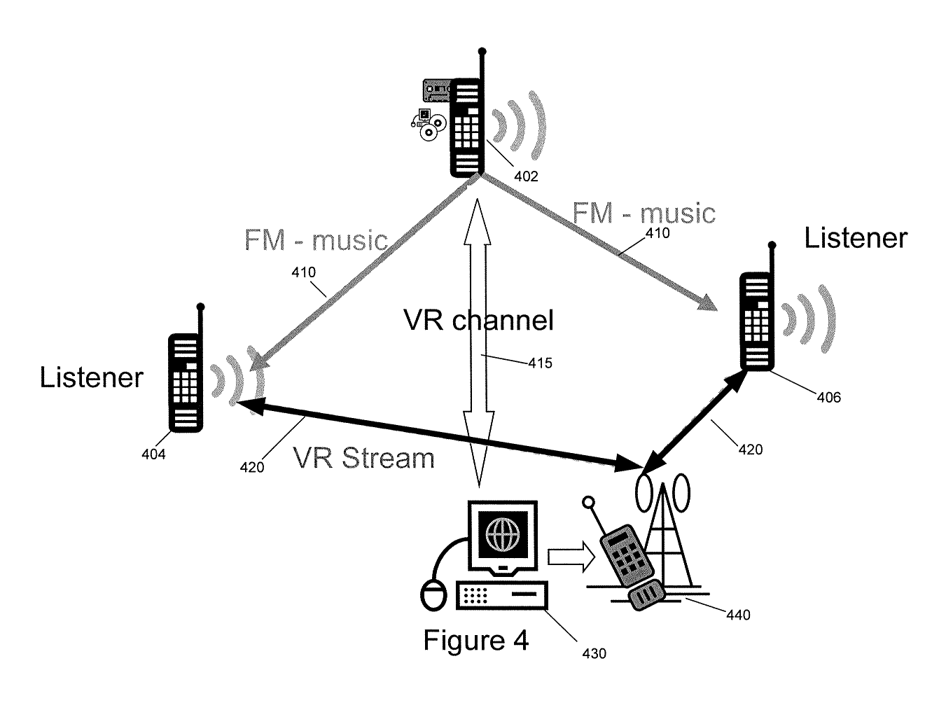

FIG. 4 illustrates an aspect of the invention in which a supplemental server 430 may be utilized to store supplemental content. A Visual Radio Server 430 may be used as a supplemental Server as the Visual Radio Server 430 may already connect media devices to available radio station feeds. In FIG. 4, the Visual Radio Server 430 connects media devices 402, 404, and 406 to available radio station feeds through broadcast station 440. A broadcasting media device 402 broadcasts a music file through a low power communication protocol through a first communication/network channel 410. The broadcasting may include FM broadcasting using an FM transmitter 286. Alternatively, the broadcasting may be accomplished through different channels as for example through a WLAN, a wireless telecommunication network, GPRS, GSM, or a low power communication protocol such as BLUETOOTH.

A user may select some images, text, audio, video, or other media to be broadcast or transmitted using the Visual Radio content delivery chain. The supplemental content may be transmitted to the Video Radio Server 430 through a second network/communication channel 415. The Visual Radio delivery system may use protocols such as GPRS, 3G, BLUETOOTH, and WLAN for delivery of the images or supplemental content. Additionally to media content, also one or more commands may be broadcast or transmitted using the Visual Radio content delivery chain to one or more second media devices 404. These commands may be used e.g. for supplemental media content selection and/or defining rendering information.

The Visual Radio Server 430 may transmit to the first media device 402 communication information pertaining to the supplemental content. The communication information may include address information of the supplemental content, such as an IP address or a telephone number. Those skilled in the art will realize other or additional location information may be forwarded to first media device 402 in order to describe the storage location of the supplemental content. The first media device 402 may transmit the communication information to a second media device 404 through first communication channel 410. If the first communication channel 410 is a FM radio channel the communication information may be transmitted by using RDS or RT+ data protocols. If the first communication channel 410 is a digital radio or television channel the communication information may be transmitted by using service or program information, such as SI table and/or service guide. Moreover, first media device 402 may transmit the communication information to numerous additional media devices such as media device 406.

The second media device 404 may contact the Video Radio Server 430 using the received communication information through a third communication channel 420 to request any supplemental content related to the received music file. Upon receiving the request, Video Radio Server 430 transmits any supplemental content information along with timing information through third communication channel 420 to the second media device 404. The timing information may be used to synchronize the music file and the received supplemental content when executed by a user of the second media device 404. Visual Radio Application 298 stored in memory 202 of media device 404 may enable a user to listen to the delivered music file and simultaneously view the synchronized video, text or pictures on media device 404.

In a further aspect of the invention, the first media device 402 may transmit to the Visual Radio Server 430 addresses of the one or more second media devices 404. The address may an IP address or a telephone number. In the next step the Visual Radio Server 430 contacts the one or more second media devices 404 via the address and if the contact request is accepted the supplemental content delivery starts.

In an aspect of the invention, in order to synchronize the music file and the supplemental content, the media device 402 may notify Visual Radio Server 430 about the music file and in particular the duration of the music file, as the duration will be known on media device 402. With this information, Visual Radio Server 430 will know when a song will be completed and may instruct a media device to terminate display of the supplemental content at the proper time. These notifications may be sent before hand and may be executed by the Visual Radio Application 298.

If songs are grouped in a play list, the playback media device knows about the next music piece that will be played on the media device. The media device may predict the moment when playback is started and may notify the Visual Radio Server 430 and VRA in turn. Alternatively, one or more play lists may be transmitted to the Visual Radio Server 430, so that the server 430 may define the supplemental media content and the communication information much before the media content itself is transmitted.

In another aspect of the invention, the Visual Radio Server 430 may use song recognition technology to make a decision regarding a particular song that is playing. A music recognition system may provide information about duration of a song, so that the end of the song can be predicted and the supplemental content may be removed in a synchronized fashion with the end of the song.

In another aspect of the invention, the first media device 402 may transmit only metadata of the selected media content or play list to the Visual Radio Server 430. By this metadata information the server 430 selects the supplemental media content from its own media content sources and databases.

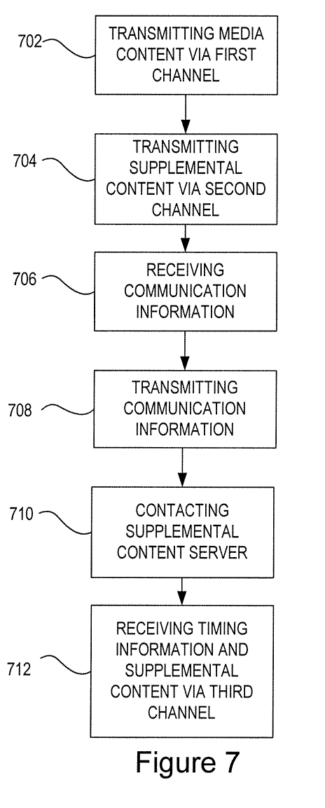

FIG. 7 illustrates a method for sharing media content and related supplemental content in accordance with an aspect of the invention. In FIG. 7 at step 702, a first media device transmits media content through a first communication channel. Next in step 704, the first media device transmits related supplemental content or its metadata with timing information to a supplemental content server through a second communication channel. The supplemental content server may be a Visual Radio Server. The supplemental content server stores the related supplemental content into memory. The supplemental content server transmits communication information pertaining to supplemental content storage location through the second communication/network channel. At step 706, the communication information is received at the first media device. Next in step 708, the first media device transmits the communication information to the second media device. If necessary, the first communication device may also transmit the communication information to other media devices. The second media device receives the communication information and in turn at step 710 contacts the supplemental content server requesting that the supplemental content related to the music file be transmitted. The supplemental content server transmits the supplemental content information along with timing information to the second media device which receives the information at a step 712. The second media device may play the music file while simultaneously rendering the supplemental content. After listening to the music file and viewing the supplemental content, a user may comment or provide feedback to the first media device through a first communication channel, such as WLAN, Bluetooth or any wireless telecommunication network. The feedback may be used to update the supplemental content stored in the first media device or to select the supplemental content transmitted.

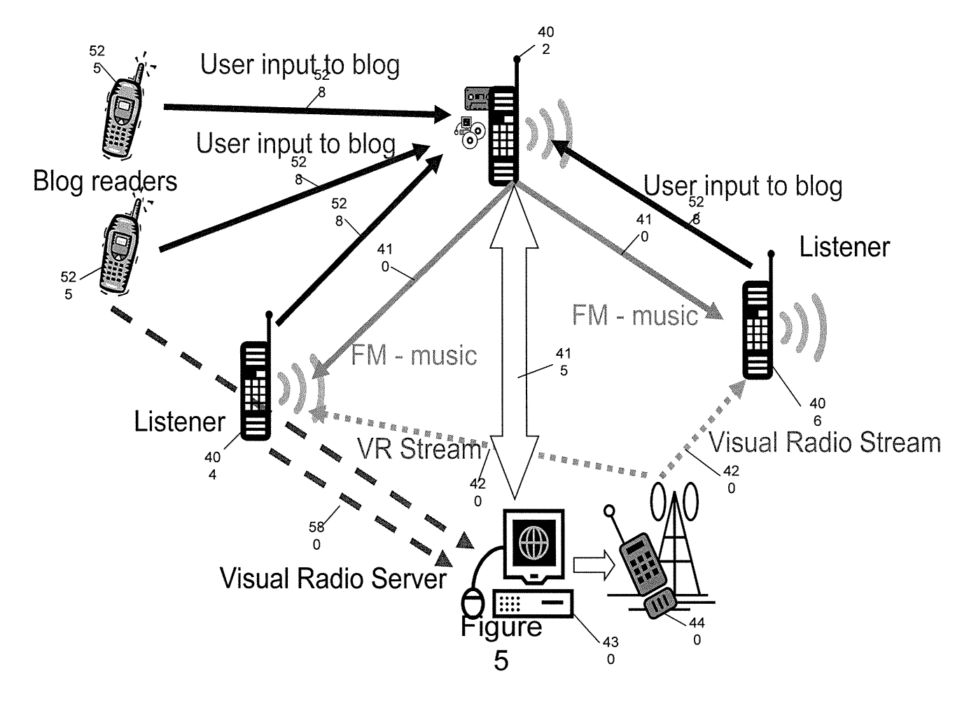

FIG. 5 illustrates an additional aspect of the invention in which a broadcasting mobile terminal such as media device 402 may be running a blogging server. End users may connect to the broadcasting terminal (media device 402) through communication channel 528 and leave their comments and new media content, such as audio, video, images and text about a currently playing song or displayed image or video, or the play list. In the alternative aspect, comments and the new media content from the media device may be communicated to a supplemental server such as Video Radio Server 430 through a communication channel 580. By the comments the supplemental media content transmission may be edited and the new content maybe added.

While the present invention has been described in connection with the illustrated embodiments, it will appreciated and understood that modifications may be made without departing from the true spirit and scope of the invention. In particular, the invention applies to any computing device adapted to receive and transmit broadcasts. Further, the radio broadcasts are not limited to FM radio, and may include analog or digital broadcasts.

Moreover, while the present invention has been described in connection with the illustrated embodiments, it will appreciated and understood that SMS and MMS messages and emails may be used in communication between the first media device 402, the second media device 404 and the Video Radio Server 430 to transmit the communication information, supplemental content, media content timing information, media content metadata information, feedback information and content, and blogging information and content.

Furthermore, while the present invention has been described in connection with the illustrated embodiments, it will appreciated and understood that any transmission standards and protocols may be used in communication between the first media device 402, the second media device 404 and the Video Radio Server 430. The transmission standards and protocols may include analog or digital radio broadcasting, analog or digital television broadcasting, WLAN, Bluetooth, short range radio communication, IrDA and/or wireless telecommunication. Further, any of the first media device 402, the second media device 404 and the Video Radio Server 430 may be connected in wired communication manner, such as in IP communication.

We claim:

1. A method for providing media content and related supplemental content from a first media device to a second media device, the method comprising:
transmitting the media content through a first network channel; and
transmitting the related supplemental content through a second network channel.

2. The method of claim 1 further comprising receiving feedback content relating to the transmitted media content or related supplemental content from the second media device through a third network channel.

3. The method of claim 2 further comprising creating updated supplemental content using the received feedback content.

4. The method of claim 1, wherein the media content comprises a music file.

5. The method of claim 1, wherein the related supplemental content comprises visual content.

6. The method of claim 1, wherein the first media device and the second media device comprise mobile communication devices.

7. The method of claim 1, wherein the first network channel provides the media content through a FM broadcast.

8. The method of claim 1, wherein the first media device and the second media device communicate through a peer to peer network.

9. The method of claim 2, wherein the feedback content comprises blog content.

10. A method for sharing media content and related supplemental content from a first media device to a second media device, the method comprising:
transmitting the media content through a first network channel from the first media device to the second media device;
transmitting the related supplemental content through a second network channel from the first media device to a supplemental content server;
receiving at the first media device communication information pertaining to the related supplemental content from the supplemental content server through the second network channel; and
transmitting the communication information pertaining to the related supplemental content to the second media device.

11. The method of claim 10, further comprising contacting the supplemental content server using the communication information through a third network channel.

12. The method of claim 10, further comprising receiving at the second media device timing information and the related supplemental content through the third communication channel.

13. The method of claim 10, wherein the media content comprises a music file.

14. The method of claim 10, wherein the related supplemental content comprises visual content.

15. The method of claim 10, wherein the first media device and the second media device comprise mobile communication devices.

16. The method of claim 10, wherein the first network channel provides the media content through a FM broadcast.

17. The method of claim 10, wherein the first media device and the second media device communicate through a peer to peer network.

18. The method of claim 10, wherein the related supplemental content information comprises metadata relating to the media content.

19. The method of claim 12, wherein the timing information comprises presentation timing information for the media content.

20. The method of claim 10, wherein communication information comprises IP information of the supplemental content server.

21. The method of claim 10, wherein the communication information comprises a telephone number.

22. A first media device for providing media content and supplemental content to a second media device, the first media device comprising:
a communication interface;
a transmitter;
a receiver;
a storage medium; and
a processor coupled to the storage medium and programmed with computer-executable instructions to perform the steps comprising:
linking the media content and the supplemental content to form related supplemental content;
transmitting the media content through a first network channel;
transmitting the related supplemental content through a second network channel;
receiving feedback content relating to the transmitted media content or related supplemental content from the second media device through a third network channel; and
creating updated related supplemental content using the received feedback content.

23. The device of claim 22, wherein the first network channel provides the media content through a FM broadcast.

24. The device of claim 22, wherein the second network channel comprises a RDS message.

25. The device of claim 22, wherein the first media device and the second media device communicate through a peer to peer network.

26. The method of claim 22, wherein the feedback content comprises blog content.

27. A media device to receive media content and related supplemental content, the media device comprising:
a communication interface;
a receiver;
a transmitter;
a storage medium; and
a processor coupled to the storage medium and programmed with computer-executable instructions to perform the steps comprising:
receiving the media content through a first network channel;
receiving the related supplemental content through a second network channel; and
transmitting feedback content relating to the received media content or related supplemental content through a third network channel.

28. A media device to receive media content and related supplemental content, the media device comprising:
a communication interface;
a receiver;
a transmitter;
a storage medium; and
a processor coupled to the storage medium and programmed with computer-executable instructions to perform the steps comprising:
receiving the media content through a first network channel;
receiving communication information through the first network channel;
contacting a content server using the received communication information through a second communication network channel; and
receiving timing information and the related supplemental content information through the second communication channel.

29. A media device to transmit media content and related supplemental content, the media device comprising:
a communication interface;
a transmitter;
a receiver;
a storage medium; and
a processor coupled to the storage medium and programmed with computer-executable instructions to perform the steps comprising:
transmitting the media content through a first network channel;
transmitting the related supplemental content through a second network channel to a supplemental content server;
receiving at the media device communication information pertaining to the supplemental content information from the supplemental content server through the second network channel; and
transmitting the received communication information pertaining to the supplemental content information through the first network channel.

30. A server for storing supplemental content information related to media content, the server comprising:
a memory;
a storage medium
a communications interface; and
a processor coupled to the storage medium and programmed with computer-executable instructions to perform the steps comprising
receiving supplemental content information from a first mobile communication device through a first network channel;
storing the supplemental content in the memory;
receiving a request for the supplemental content from a second mobile communication device through a second network channel; and
transmitting the supplemental content information to the second media device through the second network channel.

31. A method for sharing supplemental content related to media content, the method comprising:
receiving the supplemental content information from a first mobile communication device through a first network channel;
storing the supplemental content;
receiving a request for the supplemental content from a second mobile communication device through a second network channel; and
transmitting the supplemental content information to the second media device through the second network channel.
